(19) United States
(12) Patent Application Publication
(10) Pub. No.: US 2014/0001837 A1
(43) Pub. Date: Jan. 2, 2014

(54) Dual Core DC/DC Module for Electrical Vehicle

(71) Applicants: Wei Zhang, Shanghai (CN); Wei Zhong, Shenzhen (CN); Siyuan Gao, Shenzhen (CN)

(72) Inventors: Wei Zhang, Shanghai (CN); Wei Zhong, Shenzhen (CN); Siyuan Gao, Shenzhen (CN)

(73) Assignee: O2MICRO, INC., Santa Clara, CA (US)

(21) Appl. No.: 13/565,489

(22) Filed: Aug. 2, 2012

(30) Foreign Application Priority Data
Jun. 29, 2012 (CN) 201210224028.4

(51) Int. Cl. B60L 1/00; H02J 4/00

(52) U.S. Cl. 307/9.1; 307/80

(57) ABSTRACT

A power supply apparatus for delivering power to electrical devices in an electrical vehicle. The power supply apparatus is connected to a single power source and capable of delivering multiple levels of output voltage current. The power supply apparatus has two power supplies and a controller. The controller enables a primary power supply and disables a secondary power supply if the primary power supply is connected to the external power source. The controller enables the secondary power supply and disables the primary power supply if the primary power supply is not connected to the external power source.

This application claims the benefit of foreign application CN 201210224028.4, filed on Jun. 29, 2012 in the State Intellectual Property Office, the entirety of which is incorporated by reference.

### BACKGROUND OF THE INVENTION

1. Field of the Invention

The present invention generally relates to battery, and more specifically, relates to battery control.

2. Description of the Related Art

Currently each EV has two power sources: one power supply (main power supply) for providing power to the main system (which excludes the motor for moving the EV) of the EV and other power supply (backup power supply) for providing power to the auxiliary system. The backup power supply is usually a lead-acid battery. FIG. 1 illustrates a traditional scheme 100 for providing backup power to electrical equipments in an electrical vehicle. The lead-acid battery 102 is connected to the output of a DC/DC converter 104 as the backup power for electrical equipments 106 in the vehicle. The DC/DC converter 104 is connected to the main power supply (not shown) for the electrical vehicle.

There are some problems with the configuration shown in FIG. 1:
1. Lead-Acid battery is heavy and expensive, which causes trouble for EV designer.
2. If the battery hadn't been charged for a long time, the battery would be used up because of the static current, and then its voltage would be too low to start the vehicle.
3. If the battery is shorted, it would make the vehicle on fire.

Because of the above listed problems, there is a need for an apparatus that provides power to an auxiliary system without using a lead-acid battery, and it is to this apparatus the present invention is primarily directed.

### SUMMARY OF THE INVENTION

In one embodiment, the present invention provides a power supply apparatus. The power supply apparatus comprises a plurality of input connectors for connecting to a power source, a plurality of output connectors for connecting to an electrical device, a first power supply connected to the plurality of input connectors and the plurality of output connectors, a second power supply connected to the plurality of input connectors and the plurality of output connectors, and a controller in communication with the first power supply and with the second power supply, wherein the controller controls the first power supply and the second power supply, the controller controls whether each power supply outputs a current to the output connectors.

In another embodiment, the present invention provides a method for providing power to an electrical vehicle. The method comprises the steps of receiving electrical power from a power source, receiving an indication whether the electrical power is connected to a first power supply, enabling, if the electrical power is connected to the first power supply, the first power supply to output a first voltage current, and enabling, if the electrical power is not connected to the first power supply, a second power supply to output a second voltage current.

In yet another embodiment, the present invention provides a power supply apparatus connected to a power source that delivers a plurality of output voltages to an electric device. The power supply apparatus has a first power supply connected to the power source and outputting an output current to the electric device, a second power supply connected in parallel to the first power supply, and a controller receiving data from an external system and in communication with the first power supply and with the second power supply. The controller controls, according to the data received from the external system, the output voltage from the first power supply and the output voltage from the second power supply.

Other advantages and features of the present invention will become apparent after review of the hereinafter set forth Brief Description of the Drawings, Detailed Description of the Invention, and the Claims.

### BRIEF DESCRIPTION OF THE DRAWINGS

Features and advantages of embodiments of the invention will become apparent as the following detailed description proceeds, and upon reference to the drawings, where like numerals depict like elements, and in which:

FIG. 1 depicts a traditional scheme for providing a backup power to an electrical vehicle;

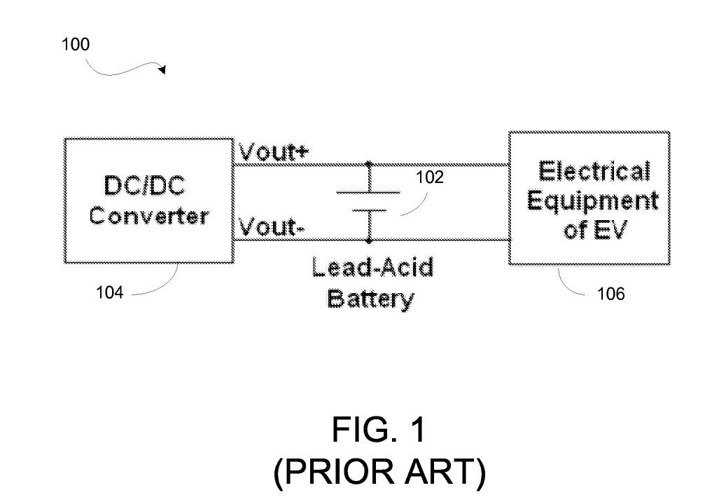

FIG. 2 illustrates a dual core DC/DC module according to one embodiment of the invention;

FIG. 3 illustrates a dual core DC/DC module according to another embodiment of the invention;

FIG. 4 is a flowchart for an operation of a dual core DC/DC module; and

FIG. 5 is a flow chart for another operation of the dual core DC/DC module.

### DETAILED DESCRIPTION OF THE INVENTION

The present invention provides a power supply apparatus and a method for proving backup power to an electrical vehicle without employing an additional lead-acid based battery. The apparatus of the present invention includes a dual core DC/DC module capable of providing power to the main electrical system in the electrical vehicle and also to the auxiliary electrical system in the electrical vehicle. The dual core DC/DC module is connected to one single power source and has two power supplies connected in parallel. Both power supplies are connected to the power source. The dual core DC/DC module also has a controller that receives information from the electric vehicle and uses the received information for controlling operation of two power supplies. The controller controls output voltage for each power supplies.

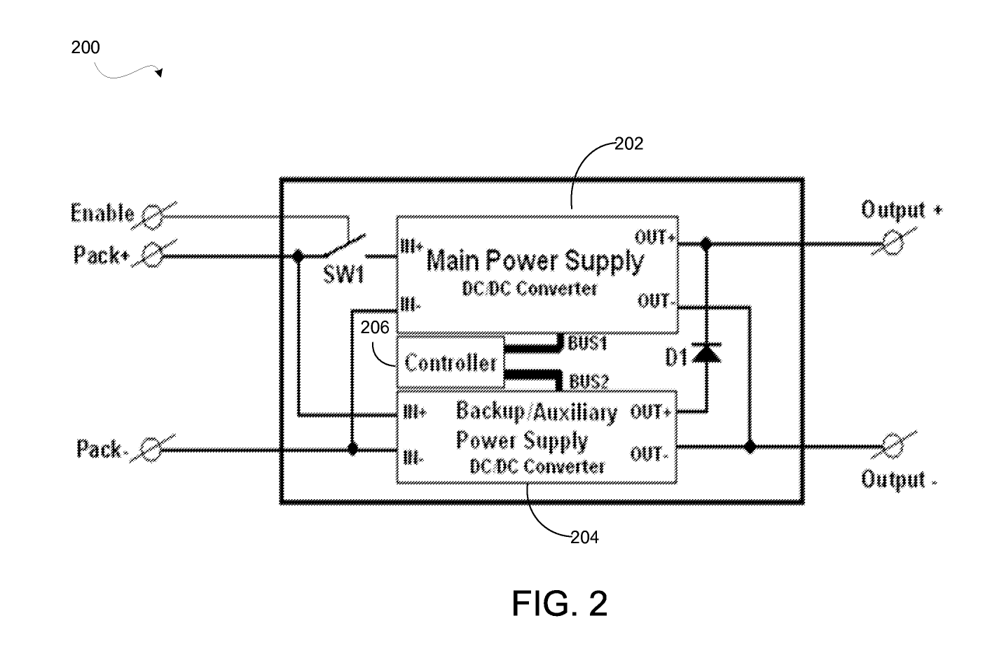

FIG. 2 illustrates a dual core DC/DC (DC to DC) module 200 according to one embodiment of the invention. The dual core DC/DC module 200 has two input connectors, Pack+ and Pack− for connecting to an external power source (not shown) on the electrical vehicle, a enable connector, Enable, from the electrical vehicle's main controlling system (not shown), and two output connectors, Output+ and Output− for connecting to the electrical system (not shown) of the electrical vehicle. The Enable connector is connected to a switch SW1. Internally, the dual core DC/DC module 200 has two power supplies, one main power supply 202 and other backup power supply 204. The dual core DC/DC module 200 also has a controller 206 that communicates with two power supplies. Each power supply has two input connectors, IN+ and IN−, and two output connectors, OUT+ and OUT−. The IN+ connectors for two power supplies are connected, so are the IN− connectors. Similarly, the OUT− for two power supplies are connected. The OUT+ of the backup power supply is connected through a diode to the OUT+ of the main power supply. The IN+ connectors of the power supplies are connected to the PACK+ connector and the IN− connectors of the power supplies are connected to the PACK− connector. The OUT+ connectors of the power supplies are connected to the Output+ connector and the OUT− connectors of the power supplies are connected to the Output− connector.

When the EV is not in operation (not moving or ignition not on), the control system (not shown in FIG. 2) of the EV does not activate the Enable signal and the switch SW1 stays open. While the switch SW1 stays open, the connectors Pack+ and Pack− are connected to the backup power supply 204 and the external power source provides power to the backup power supply 204. The backup power supply 204 then makes its low voltage current available on the Output+ and Output− connectors.

When the EV is in operation (moving or ignition is on), the control system of the EV activates the Enable signal, and the switch SW1 closes. When the switch SW1 closes, the external power source is connected to both the main power supply 202 and the backup power supply 204. The controller 206 may also receive signals from the EV's control system that indicate to the controller that EV is in operation. Alternatively, the controller 206 may learn that the EV is in operation by receiving a signal from the main power supply 202 that indicates the main power supply 202 is connected to the external power source. The controller 206 will then enables the main power supply 202 to make high voltage current available through its outputs. If the EV is not in operation, the controller 206 disables the output from the main power supply 202 and enables the output for the backup power supply 204. The high voltage current from the main power supply 202 is blocked from flowing into the backup power supply 204 by the diode D1.

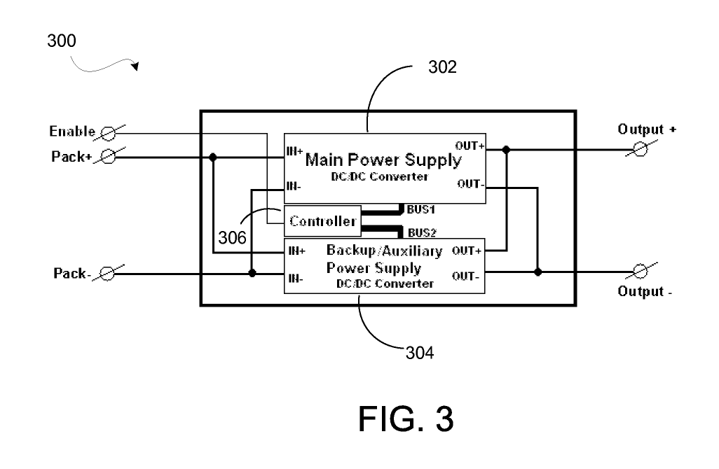

FIG. 3 is an illustration of an alternative embodiment of a dual core DC/DC module 300. The dual core DC/DC module 300 has two input connectors, Pack+ and Pack− for connecting to an external power source (not shown) on the electrical vehicle, a enable connector, Enable, from the electrical vehicle's main controlling system (not shown), and two output connectors, Output+ and Output− for connecting to the electrical system (not shown) of the electrical vehicle. Internally, the dual core DC/DC module 300 has two power supplies, one main power supply 302 and other backup power supply 304. The dual core DC/DC module 300 also has a controller 306 that communicates with two power supplies. Each power supply has two input connectors, IN+ and IN−, and two output connectors, OUT+ and OUT−. The IN+ connectors for two power supplies are connected, so are the IN− connectors. Similarly, the OUT− connectors for two power supplies are connected. The OUT+ connectors for two power supplies are connected. The IN+ connectors of the power supplies are connected to the PACK+ connector and the IN− connectors of the power supplies are connected to the PACK− connector. The OUT+ connectors of the power supplies are connected to the Output+ connector and the OUT− connectors of the power supplies are connected to the Output− connector.

The external power source is connected to both the main power supply 302 and the backup power supply 304 in the configuration of FIG. 3. When the EV is not in operation (not moving), the Enable signal is received by the controller 306 and will indicate that the EV is not in operation. The controller 306 will then enable the backup power supply 304 to make its low voltage current available on the Output+ and Output− connectors.

When the EV is in operation (moving), the control system of the EV activates the Enable signal. The controller 306 receives the Enable signal from the EV's control system that indicates to the controller that EV is in operation. The controller 306 will enables the main power supply 302 to make high voltage current available through its outputs and the controller 306 will also disable the backup power supply 304, so the backup power supply will not output any current on its output.

Though, in the scenarios described above, the main power supply and backup power supply operate in a mutually exclusive manner, two power supplies in the dual core DC/DC module of the present invention may also in tandem. For example, if the main power supply is capable of delivering 40 W of energy and the backup power supply is capable of delivering 10 W, the controller can control both power supplies and have both power supplies to deliver currents at the same voltage on their output connectors, thus making 50 W available to the electrical system in the EV. The tandem operation is accomplished by the controller reducing the output voltage of the main power supply to close to the output voltage of the backup power supply. Then the backup power supply would share its power to the load. Alternatively, the controller may also raise the output voltage of the backup power supply to be close to the output voltage of the main power supply.

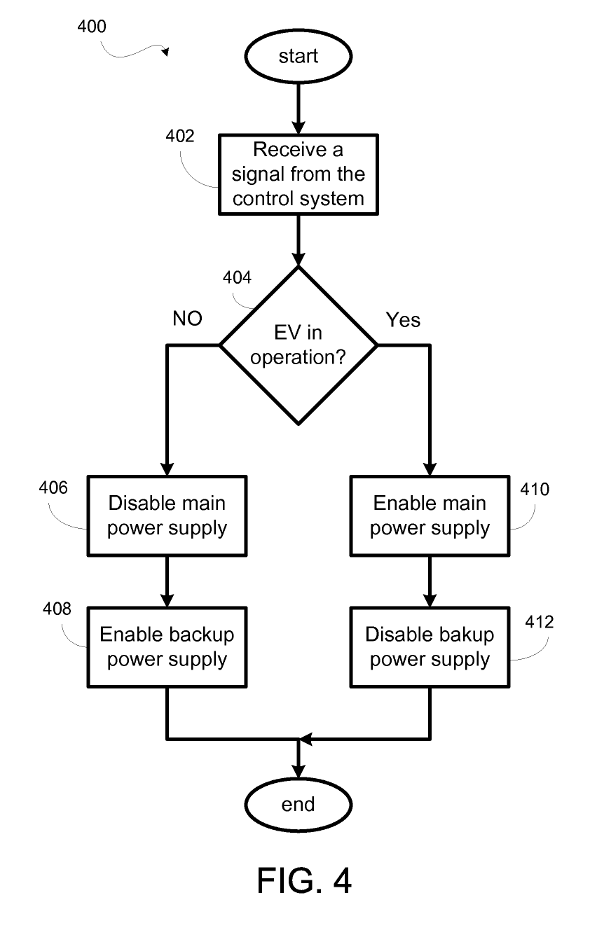

FIG. 4 is a flow chart 400 of operation of a dual core DC/DC module. The dual core DC/DC module receives a signal from the control system of an EV, step 402. The received signal indicates whether the EV is in operation, step 404. If the EV is not in operation, the controller inside the dual core DC/DC module will disable the main power, step 406, and enable the backup power supply, step 408. If the signal received indicates that the EV is in operation, the controller inside the dual core DC/DC module will enable the main power, step 410, and disable the backup power supply, step 412.

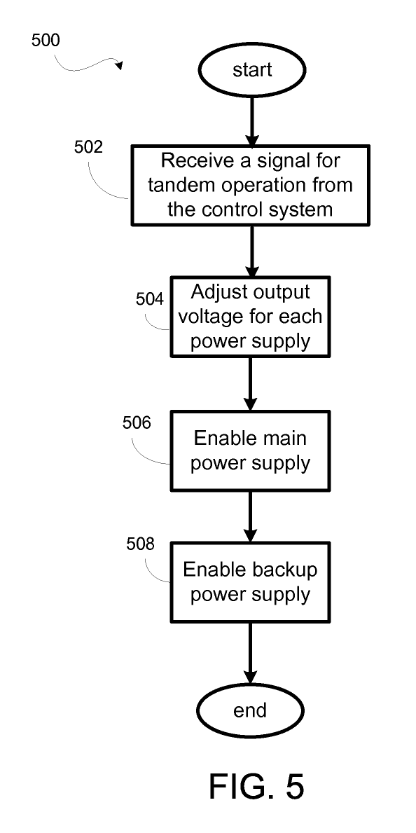

FIG. 5 is a flow chart 500 for tandem operation of a dual core DC/DC module. The dual core DC/DC module receives a signal from the control system, step 502, indicating that the dual core DC/DC module is to deliver power in the tandem mode. The dual core DC/DC module sends control signals to each power supply to adjust their output voltage to a previously defined level, step 504. After each power supply adjusts the output voltage level, the dual core DC/DC module enables the main power supply, step 506, and also enables the backup power supply, step 508. The output from both power supplies will be available on the output connectors Output+ and Output− and the power output is the combination of the power from both power supplies.

In operation, when an E/V is not in operation, the control system in the E/V does not activate the Enable signal. The external power source delivers power to the backup power system 204. The controller 206 instructions the backup power system 204 to output its low voltage current on the output connectors Output+ and Output−. The low voltage current will be available to drive electrical components, such as radio and electrical instruments, on the auxiliary system of the E/V.

When the E/V is in operation, the control system in the E/V activates the Enable signal and the switch SW1 closes. The controller 206 senses that the external power source is connected to the main power supply 202. After sensing the main power supply 202 is connected to the external power source, the controller 206 disables the output of the backup power supply 204 and enables the output of the main power supply 202. After the output of the main power supply 202 is enabled, the dual core DC/DC module can then drive, using the high voltage current, equipments, such as windshield wipers, electrical windows, and lights, in the main power system of the E/V.

While the invention has been particularly shown and described with reference to a preferred embodiment thereof, it will be understood by those skilled in the art that various changes in form and detail may be made without departing from the spirit and scope of the present invention as set forth in the following claims. The features described in different drawings may be combined. Furthermore, although elements of the invention may be described or claimed in the singular, the plural is contemplated unless limitation to the singular is explicitly stated.

What is claimed is:

1. A power supply apparatus comprising:
a plurality of input connectors for connecting to a power source;
a plurality of output connectors for connecting to an electrical device;
a first power supply connected to the plurality of input connectors and the plurality of output connectors;
a second power supply connected to the plurality of input connectors and the plurality of output connectors; and
a controller in communication with the first power supply and with the second power supply,
wherein the controller controls the first power supply and the second power supply, the controller controls whether each power supply outputs a current to the output connectors.

2. The power supply apparatus of claim 1 further comprising:
a switch connecting an input connector to the first power supply; and
an enabling signal connector for controlling the switch.

3. The power supply apparatus of claim 1, wherein the controller receives an input signal and the controller controls operation of the first power supply and the second power supply based on the input signal received.

4. The power supply apparatus of claim 1, wherein the controller receives a signal from the first power supply that indicates whether the first power supply is receiving power from the power source

5. The power supply apparatus of claim 4, wherein the controller disables the second power supply if the first power supply is receiving power from the power source.

6. The power supply apparatus of claim 4, wherein the controller, if the first power supply is not receiving power from the power source, disables the first power supply and enables the second power supply.

7. The power supply apparatus of claim 1, further comprising a diode connecting an output of the first power supply to an output of the second power supply.

8. The power supply apparatus of claim 1, wherein the controller, if the power supply apparatus is in a tandem operation, controls the first power supply and the second power supply to output a previously defined output voltage on their outputs.

9. A method, for providing power to an electrical vehicle, comprising the steps of:
receiving electrical power from a power source;
receiving an indication whether the electrical power is connected to a first power supply;
enabling, if the electrical power is connected to the first power supply, the first power supply to output a first voltage current; and
enabling, if the electrical power is not connected to the first power supply, a second power supply to output a second voltage current.

10. The method of claim 9, wherein the indication is received from a control system in the electrical vehicle.

11. The method of claim 9, wherein the indication is received from the first power supply.

12. The method of claim 9, further comprising disabling, if the electrical power is connected to the first power supply, the second power supply.

13. The method of claim 9, further comprising the steps of:
receiving an indication for tandem operation;
instructing the first power supply to output a previously defined output voltage; and
instructing the second power supply to output the previously defined output voltage.

14. A power supply apparatus connected to a power source, for delivering a plurality of output voltages to an electric device, comprising:
a first power supply connected to the power source and outputting an output current to the electric device;
a second power supply connected in parallel to the first power supply; and
a controller receiving data from an external system and in communication with the first power supply and with the second power supply,
wherein the controller controls, according to the data received from the external system, the output voltage from the first power supply and the output voltage from the second power supply.

15. The power supply apparatus of claim 14, wherein the controller controls whether the first power supply or the second power supply output an output current to the electric device.

16. The power supply apparatus of claim 14, further comprising:
a switch connecting the power source to the first power supply; and
an enabling signal connector for controlling the switch.

17. The power supply apparatus of claim 14, wherein the controller receives a signal from the first power supply to indicate whether the first power supply is receiving power from the power source.

18. The power supply apparatus of claim 17, wherein the controller disables the second power supply if the first power supply is receiving power from the power source.

19. The power supply apparatus of claim 14, wherein the controller, if the power supply apparatus is in a tandem operation, controls the first power supply and the second power supply to output a previously defined output voltage on their outputs.

20. The power supply apparatus of claim 14, further comprising a diode connecting the second power supply to the electric device.
